(19) United States
(12) Patent Application Publication
(10) Pub. No.: US 2013/0230769 A1
(43) Pub. Date: Sep. 5, 2013

(54) Silicon and lithium silicate composite anodes for lithium rechargeable batteries

(71) Applicant: WANLI XU, BATON ROUGE, LA (US)

(72) Inventor: WANLI XU, BATON ROUGE, LA (US)

(73) Assignee: ELECTROCHEMICAL MATERIALS, BATON ROUGE, LA (US)

(21) Appl. No.: 13/865,784

(22) Filed: Apr. 18, 2013

Related U.S. Application Data
(63) Continuation-in-part of application No. 13/363,947, filed on Feb. 1, 2012.

(51) Int. Cl. H01M 4/131

(52) U.S. Cl. CPC H01M 4/131
USPC 429/199; 429/211; 429/231.95; 429/224; 429/231.3; 429/223; 429/231.8; 429/217; 429/188

(57) ABSTRACT

The present invention provides composite anodes comprising particles composed of a silicon core and a lithium silicate outer layer, active and inactive anode materials, and a binder, ibr lithium rechargeable batteries, wherein the particles composed of a silicon core and a lithium silicate outer layer are prepared via treating silicon nanoparticles with lithium hydroxide in a wet process. A lithium rechargeable battery that comprises the composite anode is also contemplated. Cycle life and characteristics and capacity of a rechargeable battery adopting the composite anode can be greatly improved.

### CROSS-REFERENCE TO RELATED APPLICATIONS

This application is related to U.S. pending patent application Ser. No. 13/363,947 as a continuation in part application

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to a composite anode for lithium rechargeable batteries comprising particles composed of a silicon core and a lithium silicate outer layer, active and inactive anode materials, and a binder. The particles composed of a silicon core and a lithium silicate outer layer are prepared via treating silicon nanoparticles with lithium hydroxide in a wet process. A lithium rechargeable battery that comprises the composite anode is also contemplated. Cycle life and characteristics and capacity of a rechargeable battery adopting the composite anode can be greatly improved.

2. Description of the Related Art

Silicon has become a promising candidate to replace carbonaceous materials as anode for rechargeable lithium ion batteries for its ultra-high capacity. Large volumetric increases upon lithium insertion of over 300% have been observed for bulk silicon. This volumetric increase along with the cracking and pulverization associated with the charge and discharge cycles has prohibited the use of bulk silicon anodes in practice.

Continuous research efforts in silicon anodes for lithium ion batteries have resulted in limited success. Since bulk silicon is not suitable as an anode material for lithium ions, composite anodes with silicon particles and other active and inactive materials have been applied in lithium rechargeable batteries. Recent works with nano-scale silicon in lithium ion cells, including silicon nanowires, structured silicon particles, 3-D structured silicon nanoclusters, and others, have shown that near theoretical capacities are achievable; unfortunately, capacity losses with cycling remain significant.

Coating silicon particles with a conductive layer, e.g. carbon, has shown great improvement in silicon composite anode performance in previous studies. The publication titled “Characterization of carbon-coated silicon—Structural evolution and possible limitations” by Dimov et al. discussed the effects of carbon coating on silicon particles with increasing conductivity within an anode matrix as well as mitigating anode mechanical failure, and showed significant improve in silicon composite anode performance. The publication titled “Surface-Coated Silicon Anodes with Amorphous Carbon Film Prepared by Fullerene C-60 Sputtering” by Arie et al. coated silicon with C.sub.60 fullerene, and demonstrated near theoretical silicon anode capacity for 50 cycles.

Lithium silicate has been demonstrated as an anode material for lithium rechargeable batteries and shows decent cycle performance when mixed with other anode active materials such as silicon. Miyachi et al. in U.S. Pat. No. 8,377,951 describes that an anode comprising lithium silicate and at least one noble metal exhibits higher initial charge/discharge efficiency, higher energy density and improved cycle properties compared to conventional anode materials. Tahara et al. in U.S. Pat. No. 5,395,711 also describes that a silicate containing lithium used as an anode active material is able to reduce electrode internal resistance and electrode deterioration, so as to improve capacity and cycle performance for lithium rechargeable batteries.

However, none of the above cited publications or patents completely solve the issues associated with anode capacity or cycle life. Thus, there exists an ongoing need for developing a novel silicon anode surface coating with conductive and protective materials so as to improve anode capacity and cycle life.

### SUMMARY OF THE INVENTION

In one embodiment of the present invention, a composite anode is disclosed comprising particles composed of a silicon core and a lithium silicate outer layer, anode active and inactive materials, and a binder. The lithium rechargeable battery of this embodiment is also disclosed.

In another embodiment of the present invention, a facile process is disclosed that creates the particles composed of a silicon core and a lithium silicate outer layer.

### BRIEF DESCRIPTION OF THE DRAWING

Not Applicable

### DETAILED DESCRIPTION OF THE INVENTION

The present invention is believed to be applicable to a variety of different types of lithium rechargeable batteries and devices and arrangements involving silicon composite electrodes. While the present invention is not limited by the disclosed embodiments, various aspects of the invention may be appreciated through a discussion of examples using the context.

According to one embodiment of the invention, a composite anode comprising particles composed of a silicon core and a lithium silicate outer layer, anode active and inactive materials, and a binder are disclosed; wherein the particles composed of a silicon core and a lithium silicate outer layer are present in the anode in an amount with a range from 5 to 30 wt. % based on the total weight of the anode. The composition of the particles in composite anode is optimized based on experimental results. When the particles composed of a silicon core and a lithium silicate outer layer are present in the composite anode in an amount below 5 wt. %, negligible anode specific capacity increase is achieved. When the particles composed of a silicon core and a lithium silicate outer layer are present in an amount over 30 wt. %, severe deterioration is demonstrated in the composite anode due to silicon volumetric expansion during charge an discharge cycles as well fading capacity and poor cycle performance.

According to another embodiment of the invention, the silicon core has a diameter range from 50 to 300 nanometers, and the lithium silicate outer layer has a thickness range from 10 to 200 nanometers. The particles composed of a silicon core and a lithium silicate outer layer have a diameter range from 60 nanometers to 500 nanometers. The silicon core diameter and lithium silicate outer layer thickness are optimized based on theoretical calculation and experimental results to achieve maximum capacity and cycle performance improvement. Based on theoretical studies as well as extensive tests, silicon particles tend to crack or pulverize when lithiated if particle diameter exceeds 300 nanometers; therefore a maximum silicon core diameter of 300 nanometers is selected. Moreover, the lithium silicate outer layer functions as a protective layer for the silicon core and retained negligible capacity compared to silicon; a maximum thickness of 200 nanometers is defined to avoid substantial energy density decrease due to the lithium silicate outer layer.

According to another embodiment of the invention, the particles composed of a silicon core and a lithium silicate outer layer can be created via the following process: (a) producing a mixture of a starting materials containing the initial components silicon particles, and LiOH aqueous solution as the main components. The initial silicon particles are 10 nanometers to 10 micrometers in diameter with a more preferred diameter range from 100 nanometers to 5 micrometers. The LiOH aqueous solution concentration ranges from 0.1 to 2 moles per liter with a preferred concentration of 0.5 molar. The initial silicon particle to LiOH molar ratio ranges from 15:1 to 8:1, with a preferred ratio of 10:1. (b) evaporating the mixture into dry powder, wherein the evaporation is carried out in vacuum evaporator at 100 degrees Celsius for 30 minutes. (c) subjecting the dried mixture to a heat treatment, wherein the heat treatment is carried out in a vacuum furnace at a preferred temperature range from 500 to 600 degrees Celsius with a more preferred temperature at 550 degrees Celsius, for 1-4 hours with a preferred time of 2 hours. The preferred temperature ramp is 25-75 degrees Celsius per minute with a preferred ramp at 50 degrees Celsius per minute. (e) cooling the mixture comprising silicon and lithium silicate to ambient temperature, and (f) grinding the mixture via ball milling for 24 hours until the final particle size is less than 500 nanometers. XPS and TEM characterization have suggested that the resulting silicon particles are covered with a lithium silicate outer layer of approximately 100 nanometers.

In connection with another embodiment of the present invention, an arrangement for use in a battery is implemented. The arrangement includes that the particles comprised of silicon and lithium silicate are mixed with carbonaceous materials and a polymer binder. The anode active materials can be selected from, but are not limited to, materials such as carbon, silicon, germanium, tin, indium, gallium, aluminum, boron, or combinations thereof. The anode inactive materials can be selected from, but are not limited to, materials such as silver, copper, nickel, and combinations thereof. The binder may be, but is not limited to, polyvinylidene fluoride, sodium carboxymethyl cellulose, styrene-butadiene rubber, and combinations thereof. In this fashion, the arrangement can be used as an anode in a lithium rechargeable battery. The anode active and inactive materials and binders may be obtained from various sources, as well as other materials that are known in the manufacture of prior art electrodes, although these sources are not elucidated here.

Consistent with one embodiment of the present invention, a battery is implemented with the anode, a cathode, a separator and a non-aqueous electrolyte. The cathode is comprised of LiCoO₂ or LiMnO₄ compounds, carbonaceous materials, and a polymer binder. The electrolyte can be a mixture of a lithium compound and an organic carbonate solution. The lithium compound may be, but is not limited to lithium hexafluorophosphate, lithium tetrafluoroborate, lithium perchloride, lithium bix(oxatlato)borate. The organic solution may be comprised of, but is not limited to, any combination of ethylene carbonate, dimethyl carbonate, diethyl carbonate, propylene carbonate, vinylene carbonate, and combination thereof. The separator membrane can be a multiple polymer membrane.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### Examples

While embodiments have been generally described, the following examples demonstrate particular embodiments in practice and with advantages thereof. The examples are given by way of illustration only and are not intended to limit the specification or the claims in any manner. The following illustrates exemplary details as well as characteristics of such particles composed of silicon and lithium silicate as active anode materials for lithium ion batteries.

A liquid suspension mixture was prepared by dispersing 0.5 grams of silicon nanoparticles (average particles size below 100 nanometer) in 15 milliliters of a 0.5 molar LiOH aqueous solution. The resulting mixture was heated at 100 degrees Celsius with continuous agitation and sufficient ventilation until dry. This took approximately 30 minutes. The dried mixture was then heated at 550 degrees Celsius for 2 hours. The dried mixture was then cooled to ambient temperature, ball milled for 24 hours. The resulting particles were comprised of a silicon core with an outer shell of lithium silicate as characterized via TEM. The silicon particles with a lithium silicate outer layer were then well mixed with 0.5 grams of carbon black (average particle size less than 50 nanometer), 3.5 grams of natural graphite (average particle size less than 40 micrometer), and 10 milliliters of 5 w.t. % polyvinylidene fluoride in n-methylpyrrolidone solution. The resulting mixture was then applied to a copper foil (˜25 micrometer in thickness) using a doctor blade method so as to deposit a layer of approximately 100 micrometers. The film was then dried in vacuum at 120 degrees Celsius for 24 hours.

The sample was assembled and evaluated as an anode in a lithium rechargeable coin cell CR2032 with pure lithium metal as the other electrode. A disk of 1.86 cm² was punched from the film as the anode, where the anode active material weight was approximately 5 micrograms. The other electrode was a lithium metal disk with a thickness of 250 micrometers and having the same surface area as the anode. Microporous trilayer membrane (Celgard 2320) was used as separator between the two electrodes. Approximately 1 milliliter of 1 mole per liter LiPF₆ in a solvent mixture comprising ethylene carbonate and dimethyl carbonate with a 1:1 volume ratio was used as the electrolyte in the lithium cell. All of the above experiments were carried out in glove box system under argon atmosphere with less then 1 part per million water and oxygen.

The assembled lithium coin cell was taken out of the glove box and stored in ambient condition for another 24 hours prior to testing. The coin cell was charged and discharged at a constant current of 0.5 mA, using the charge and discharge rate of approximately C/5 from 0.05 V to 1.5 V versus lithium for hundreds of cycles. The resulting coin cell demonstrated near theoretical capacity for over 200 cycles with less than 10% capacity fade.

The preferred embodiment of the present invention has been disclosed and illustrated. The invention, however, is intended to be as broad as defined in the claims below. Those skilled in the art maybe able to study the preferred embodiments and identify other ways to practice the invention differently than those as described herein. It is the intent of the inventors that variations and equivalents of the invention are with in the scope of the claims below and the description and abstract are not to be used to limit the scope of the invention.

The invention claimed is:

1. A composite anode comprising particles for lithium rechargeable batteries composed of a silicon core and a lithium silicate outer layer, anode active and inactive materials, a binder, and a current collector.

2. The composite anode according to claim 1, wherein the particles composed of a silicon core and a lithium silicate outer layer are present in the composite anode in an amount from 5 to 30 wt. % based on the total weight of the anode.

3. The composite anode according to claim 1, wherein the lithium silicate outer layer covers at least 95% of a surface of the silicon core.

4. The composite anode according to claim 1, wherein the silicon core has a diameter range from 50 to 300 nanometers.

5. The composite anode according to claim 1, wherein the lithium silicate outer layer has a thickness range from 10 to 200 nanometers.

6. The composite anode according to claim 1, wherein the particles composed of a silicon core and a lithium silicate outer layer have diameter range from 60 nanometers to 500 nanometers.

7. The composite anode according to claim 1, wherein the anode active material is selected from carbon, silicon, germanium, tin, indium, gallium, aluminum, boron, or combinations thereof.

8. The composite anode according to claim 1, wherein the anode inactive material is selected from silver, copper, nickel, or combinations thereof.

9. The composite anode according to claim 1, wherein the binder is selected from polyvinylidene fluoride, sodium carboxymethyl cellulose, styrene-butadiene rubber, or combinations thereof.

10. The composite anode according to claim 1, wherein the current collector is a copper foil with a thickness range from 5 to 25 micrometers.

11. The composite anode according to claim 1, wherein the anode specific discharge capacity is maintained at above 500 mAh/g after 500 cycles at charge/discharge rate of C/5 and 70% depth of discharge in half cell configuration.

12. A lithium rechargeable battery comprising a composite anode wherein the composite anode is comprised of a silicon core and a lithium silicate outer layer, anode active and inactive materials, a binder an electrolyte, a cathode comprising at least one cathode active material, and a separator disposed between the composite anode and the cathode.

13. The cathode active material of claim 12 wherein the cathode active material is selected from lithium manganese oxide, lithium cobalt oxide, lithium ion phosphate, lithium nickel cobalt oxide, or lithium nickel manganese oxide.

14. The lithium rechargeable battery of claim 12, wherein the cathode includes carbonaceous materials.

15. The lithium rechargeable battery of claim 12, wherein the cathode includes at least one polymer binder.

16. The polymer binder of claim 15 wherein the binder material is polyvinylidene fluoride, sodium carboxymethyl cellulose, styrene butadiene rubber or combinations thereof.

17. The lithium rechargeable battery of claim 12, wherein the cathode further includes a current collector comprised of an aluminum foil and having a thickness of from 5 to 25 micrometers.

18. The lithium rechargeable battery of claim 12, wherein the electrolyte includes a lithium compound.

19. The lithium rechargeable battery of claim 18 wherein the electrolyte is lithium hexafluorophosphate, lithium tetrafluoroborate, or lithium perchlorate.

20. The lithium rechargeable battery of claim 12, wherein the separator is a microporous membrane.
